(19) United States
(12) Patent Application Publication
(10) Pub. No.: US 2010/0206111 A1
(43) Pub. Date: Aug. 19, 2010

(54) BELT-TENSIONING DRIVE FOR THE SEATBELT OF A VEHICLE WITH A CUP BEARING FOR THE ROTOR SHAFT OF AN ELECTRIC MOTOR

(76) Inventors: Roland KELLER, Bergtheim (DE); Uwe Henning, Wuerzburg (DE)

Correspondence Address: Muncy, Geissler, Olds & Lowe, PLLC, 4000 Legato Road, Suite 310, FAIRFAX, VA, 22033, US

(21) Appl. No.: 12/707,217

(22) Filed: Feb. 17, 2010

Related U.S. Application Data
(63) Continuation of application No. PCT/EP2008/060061, filed on Jul. 31, 2008.

(30) Foreign Application Priority Data
Aug. 17, 2007 (DE) 10 2007 038 916.9

(51) Int. Cl. B60R 22/46; F16H 1/20; F16C 27/00

(52) U.S. Cl. 74/412 R

(57) ABSTRACT

A belt-tensioning drive is provided that has an electric motor containing a rotor shaft, and has a gear shaft and an output gear. The electric motor drives the gear shaft via a first gearing. The gear shaft, for its part, drives the output gear via a second gearing. The gear shaft is mounted in a gearbox via two bearings. An end region of the rotor shaft is mounted in a cup bearing which is placed in a cup bearing seat of the gearbox.

This nonprovisional application is a continuation of International Application No. PCT/EP2008/060061, which was filed on Jul. 31, 2008, and which claims priority to German Patent Application No. 10 2007 038 916.9, which was filed in Germany on Aug. 17, 2007, and which are both herein incorporated by reference.

### BACKGROUND OF THE INVENTION

1. Field of the Invention

The present invention relates to a belt-tensioning drive which has an electric motor containing a rotor shaft, and has a gear shaft and an output gear, wherein the electric motor drives the gear shaft via a first gear train, and the gear shaft in turn drives the output gear via a second gear train, and wherein the gear shaft is mounted in a gear housing via two bearings.

2. Description of the Background Art

A belt-tensioning drive is known from WO 2003/099 619 A2, for example.

In power-window or sunroof motors on the market today, a spherical bearing is generally used for the radial bearing of the rotor shaft of the drive motor. The axial bearing of the rotor shaft and an axial compensation for play are frequently carried out with the use of axial thrust washers. In this context, either thrust washers of one of many different material thicknesses are used for the compensation of play, which requires that each individual drive be measured, or adjusting screws or elastic spring elements are used. It has also already been proposed to ensure axial thrust of the rotor shaft by means of a crown wheel pinion. Here, the rotor shaft is inserted in the crown wheel pinion, which bears axially against the gear housing.

From EP 0 655 358 A1 is known an apparatus for adjusting components of a motor vehicle between two end positions. This apparatus has an electric drive motor whose direction of rotation can be reversed, and a worm drive located after said motor. Its worm drive is placed between two shoulders that face one another when viewed in the direction of the rotational axis of the shaft and are located a distance from one another, and is provided with mating shoulders associated with the shoulders. The two pairs of shoulders and mating shoulders are joined to one another by preloaded spring means. The worm shaft, together with the shoulders joined to its mating shoulders, can be moved in the direction of its axis of rotation counter to the force of one or other of the spring means.

From DE 197 14 237 C1 is known a drive apparatus with a device housing and, located therein, an electric motor and a worm drive. The worm drive has a worm gear and a worm shaft, wherein a shaft constitutes both an armature shaft and a worm shaft. Located on both sides of the shaft are axial bearings, of which at least one is axially elastic in design, is supported in the housing, and has a spring element. This element consists of a spring plate with an essentially circular defined central zone. The latter forms a sliding surface directed against the shaft. Radiating out from the zone are spring fingers, which are bent away at an angle from a reference plane of the zone so that their free ends can bear against an inner surface of a housing floor belonging to the housing. Also radiating out from the zone are centering tabs. The advantage of such an apparatus is thought to be that only one component, which constitutes both a spring element and a thrust washer, needs to be introduced into the device housing before installation of a radial bearing.

From DE 295 13 699 U1 is known an arrangement for adjusting the axial clearance of a shaft, supported on plain bearings, of a small motor drive, which is provided in particular for driving the motor gear shaft of a motor vehicle power-window drive or the like. In this prior art arrangement, an elastic, disk-shaped thrust part with a deformation/spring characteristic such that the contact force is small and essentially constant during an axial clearance motion of the shaft within the maximum axial clearance, but is increased upon reaching the maximum axial clearance in the manner of an inelastic limit stop. In addition, the elastic, disk-shaped thrust part contacts a dimensionally stable supporting disk at each of its axial end faces.

### SUMMARY OF THE INVENTION

It is therefore an object of the present invention to provide a belt-tensioning drive that is compactly built and easy to install.

This object is attained, in an embodiment, in that the construction of the drive can be compact due to the elimination of the axial thrust plate provided in prior art drives. In addition, installation of the rotor shaft is simplified, since there is no need for separate installation of a radial bearing and an axial bearing. The cup bearing absorbs the radial as well as the axial forces of the rotor shaft.

The belt-tensioning drive according to an embodiment of the invention can contain a spring element positioned between the base of the cup bearing seat and the base of the cup bearing, which spring element can be implemented as a spring washer and brings about axial compensation. The drive here is designed such that the rotor shaft bears axially against the opposite bearing, which is to say against the bearing located in the motor housing, during operation in the primary actuation direction. If the rotor shaft is operated in the opposite direction and with reduced load, then the rotor shaft bears against the spring element through the cup bearing. In order to prevent overloading of the spring element in this process, a step is advantageously provided in the gear housing that prevents full compression of the spring element.

In an embodiment, the rotor shaft can be always held under defined preloading in the cup bearing due to the permanent pressure of the loaded spring element. As a result, the overall cup bearing height always corresponds to the effective bearing surface of the rotor shaft, so that support of the rotor shaft is improved.

The outside of the side wall of the cup bearing can be concave in the axial direction and the inside of the side wall of the cup bearing seat is straight in design. This advantageously permits an at least slight axial tilting of the cup bearing in the cup bearing seat. Angular error of the rotor shaft can be compensated in this way.

In an embodiment, the cup bearing can be mounted in the gear housing in a rotationally fixed manner. This can be achieved by the means that the outside of the cup bearing side wall has a groove extending in the axial direction and the inside of the side wall of the cup bearing seat is provided with a projection engaging the groove. Alternatively, this can also be achieved by the means that the outside of the cup bearing side wall and the inside of the side wall of the cup bearing seat each have the form of a polygon in the circumferential direction. This measure ensures that the cup bearing inserted in the cup bearing seat in an interlocking manner does not turn during operation of the drive.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view to explain how a belt-tensioning drive functions,

FIG. 2 is a perspective view of the components of a belt-tensioning drive placed in a gear housing,

FIG. 3 is a view to illustrate installation of a belt-tensioning drive in the B-pillar of a motor vehicle,

FIG. 4 is a sectional view of a part of a belt-tensioning drive,

FIG. 5 is an enlarged view of a part from FIG. 4,

FIG. 6 is the view from FIG. 5 with explanatory symbols,

FIG. 7 is a view of a cup bearing with a first exemplary embodiment of an anti-rotation device, and

FIG. 8 is a view of a cup bearing with a second exemplary embodiment of an anti-rotation device.

### DETAILED DESCRIPTION

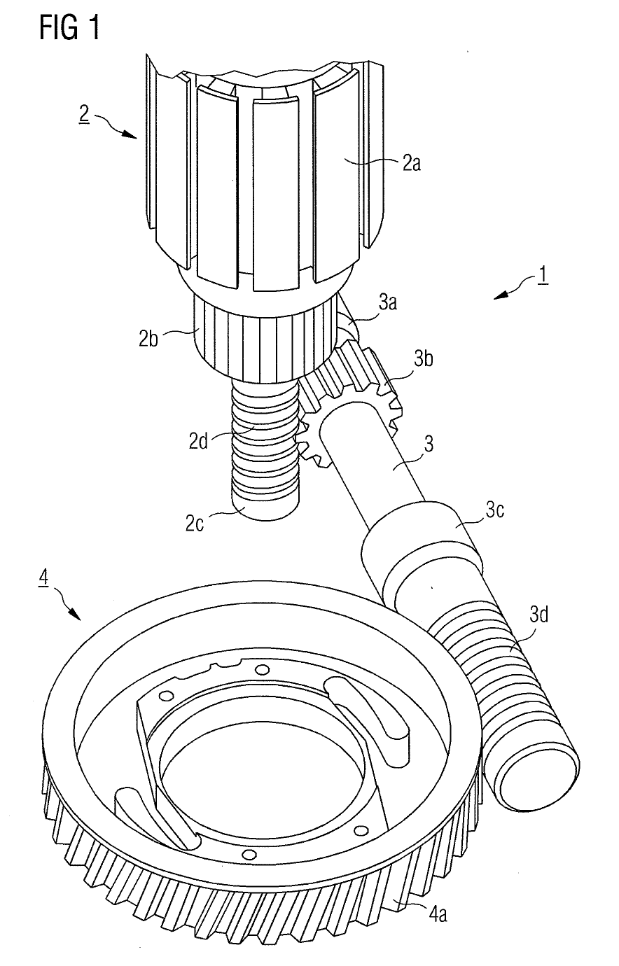

FIG. 1 shows a perspective view for explaining how a belt-tensioning drive functions. The belt-tensioning drive 1 shown has an electric motor 2, of which the rotor assembly 2a, a commutator 2b, a rotor shaft 2c, and a worm 2d inserted in the rotor shaft are shown. The rotor assembly 2a and the commutator 2b are attached to the rotor shaft 2c in a rotationally fixed manner. In addition, the belt-tensioning drive 1 has a gear shaft 3. The latter is provided with a worm gear 3b that is attached thereto in a rotationally fixed manner. In addition, the gear shaft 3 has an additional worm 3d placed therein. For mounting of the gear shaft in a gear housing, which is not shown, a first bearing 3a and a second bearing 3c are provided, which are spherical bearings. Furthermore, the belt tensioning drive 1 has an output gear 4, which is a worm gear. This worm gear is provided with external teeth 4a on its outer circumference. The winding shaft of a motor vehicle seatbelt, not shown in FIG. 1, is placed in the interior recess of the output gear 4.

The electric motor 2 drives the gear shaft 3 through a first gear train. The first gear train is composed of the worm 2d of the rotor shaft and the worm gear 3b that is connected to the gear shaft in a rotationally fixed manner, wherein the worm gear 3b meshes with the worm 2d. This first gear train is a worm drive that is implemented in the form of a 90° angle drive. The rotor shaft of the electric motor 2 and the gear shaft 3 are arranged at right angles to one another.

The gear shaft 3 drives the output gear 4 through a second gear train. This second gear train is composed of the worm 3d of the gear train and the output gear 4, with the external teeth 4a, coupled with the winding shaft, wherein the worm 3d, which preferably is made of plastic, meshes with the output gear 4. This second gear train is also a worm drive that is implemented in the form of a 90° angle drive. The gear shaft 3 and the winding shaft of the seatbelt coupled with the output gear 4 are arranged at right angles to one another. Alternatively, the second gear train can also be a spur gear.

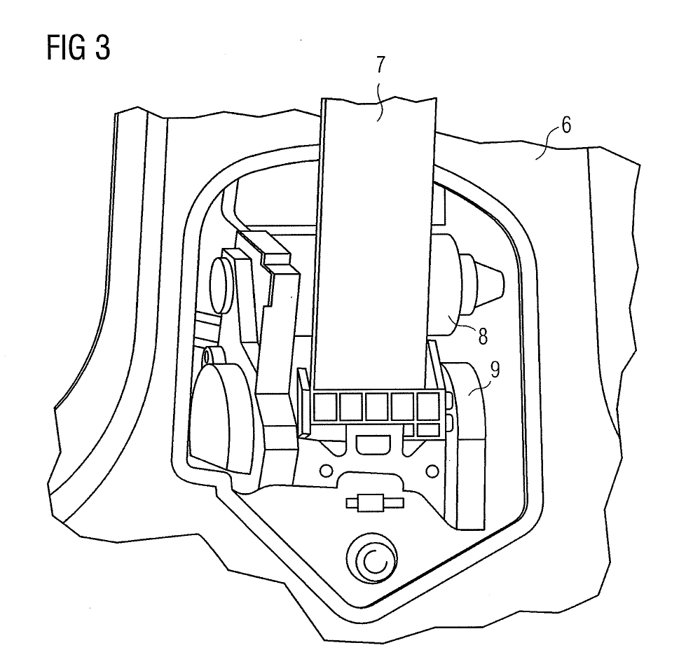

The use of two 90° angle drives achieves the result that the rotor shaft 2c and the winding shaft that is not shown in FIG. 1 extend parallel to one another. This supports a space-saving construction of the belt-tensioning drive, as will be described below with reference to FIG. 3.

The use of a worm drive as the first gear train achieves the result that a rolling engagement of the teeth of the worm gear 3b in the worm 2d takes place in operation. As a result, the drive operates with little noise and little vibration.

In addition, the functionality of a belt-tensioning drive is improved. This functionality of a belt-tensioning drive demands that the force of forward displacement produced as a result of the fact that a vehicle occupant exerts strong pressure on the seatbelt during braking of the vehicle be counteracted. This exertion of a strong pressure on the seatbelt corresponds to the attempt to rotate the gear train in the reverse direction.

In a prior art belt-tensioning drive developed by the applicant, an appropriate design of the helix angle of the second worm drive achieves the result that the latter in the reverse direction or driven direction has poorer efficiency than in the forward direction or driving direction. With regard to the first gear train, which in the prior art belt-tensioning drive developed by the applicant is a crown wheel drive, the efficiency in the reverse direction matches the efficiency in the forward direction. In order to counteract the aforesaid force of forward displacement better than just the aforesaid design of the helix angle of the second worm drive, in the prior art belt-tensioning device the polarity of the electric motor is reversed with a current level of approximately one third the maximum blocking current.

A reverse polarity with such a current level is not strictly necessary in the belt-tensioning drive shown in FIG. 1. The reason for this is that in this belt-tensioning drive, the self-locking effect of the gear train is enhanced by the means that the first gear train is also a worm drive. Due to the tandem connection of two worm drives, one advantageously obtains adequate efficiency in the forward or driving direction, and the desired self-locking or stiffness in the reverse direction. When needed, the self-locking effect can be additionally supported by a reverse polarity of the motor with a low current level.

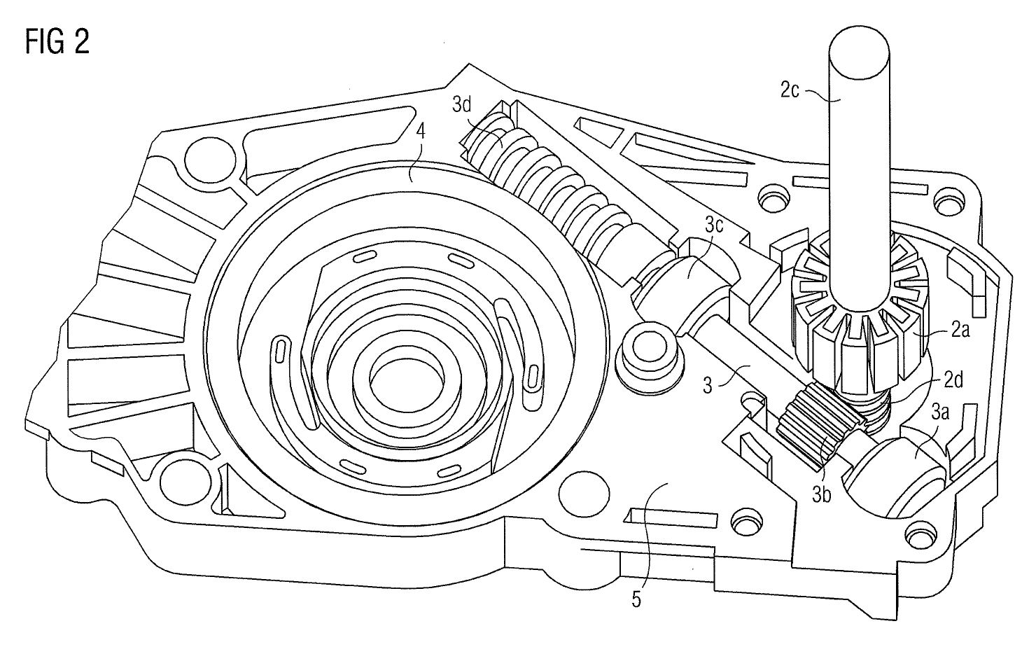

FIG. 2 shows a perspective view of the components of a belt-tensioning drive placed in a gear housing. In particular, it can be seen from FIG. 2 that the rotor shaft 2c of the electric motor projects vertically upward from the plane formed by the gear housing 5, that the gear shaft 3 lies in the plane formed by the gear housing 5, and that the winding shaft—which again is not shown in FIG. 2—of the seatbelt, which is connected to the output gear 4 in a rotationally fixed manner and is inserted axially in the recess provided in the center of the output gear 4, is likewise arranged at a right angle to the plane formed by the gear housing 5. It is also evident from FIG. 2 that the winding shaft of the seatbelt used in the output gear 4 extends parallel to the rotor shaft 2c of the electric motor, so that on the whole a compact construction of the belt-tensioning drive is provided.

This compact construction of a belt-tensioning drive makes for space-saving installation of the belt-tensioning drive in the B-pillar of a motor vehicle. This is illustrated in FIG. 3, where the B-pillar is labeled 6, the seatbelt is labeled 7, the housing of the electric motor is labeled 8, and the housing of the belt retractor is labeled 9. It is evident from FIG. 3 that the electric motor of the belt-tensioning drive is placed above the belt retractor in a space-saving manner. Alternatively, the electric motor can also be arranged horizontally beneath the belt retractor.

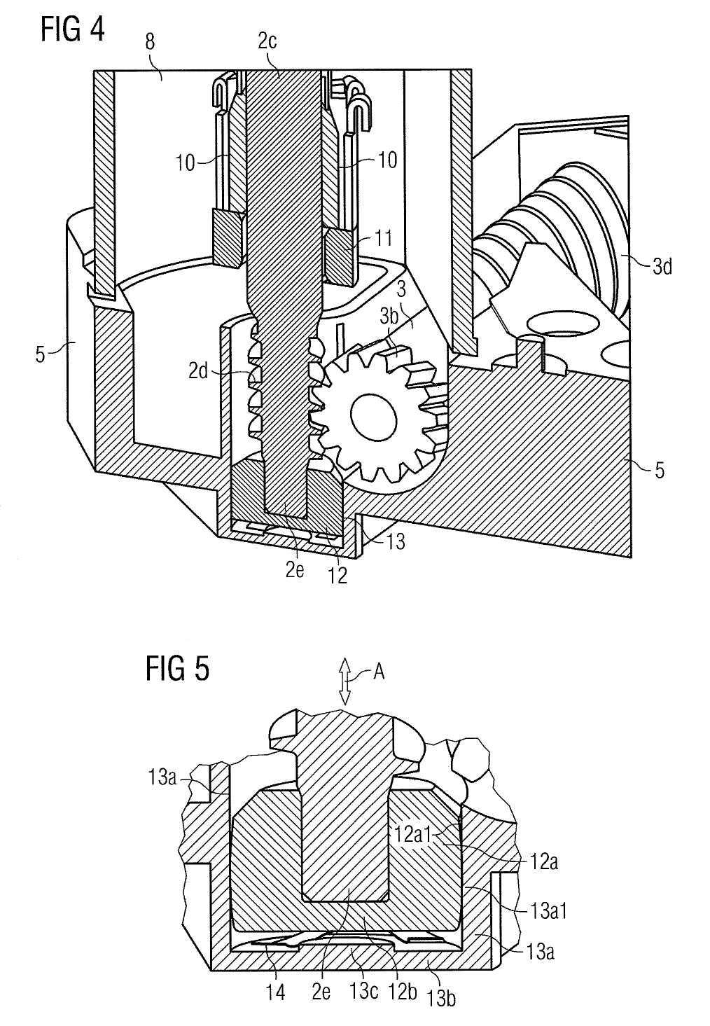

In the belt-tensioning drive shown in FIG. 2, support of the lower end region of the rotor shaft 2c is required in a bearing of the gear housing 5. An exemplary embodiment for such a support is explained in detail below with reference to FIG. 4.

The latter shows a sectional view of a part of a belt-tensioning drive.

Shown in this sectional view are the housing 8 of the electric motor, the rotor shaft 2c with the segments 10 of the commutator 2b attached thereto, a magnet ring 11 attached to the rotor shaft 2c, the worm 2d inserted in the rotor shaft 2c, and the end region 2e of the rotor shaft 2c located below the worm 2d.

In addition, it is evident from FIG. 4 that the worm 2d meshes with the worm gear 3b provided on the gear shaft 3.

Furthermore, it is evident from FIG. 4 that the end region 2e of the rotor shaft 2c is mounted in a cup bearing 12, which is inserted in a cup bearing seat 13 of the gear housing 5.

FIG. 5 shows an enlarged view of the part from FIG. 4 that surrounds the cup bearing 12. The cup bearing 12 has a circumferential cup bearing side wall 12a and a cup bearing base 12b. The cup bearing seat of the gear housing contains a circumferential cup bearing seat side wall 13a and a cup bearing seat base 13b.

The cup bearing seat base 13b has a step 13c that is inwardly directed, which is to say directed towards the cup bearing base 12b; said step is provided in the central region of the cup bearing seat base 13b. In addition, a spring element 14 is introduced in the region between the cup bearing seat base 13b and the cup bearing base 12b, said spring element preferably being a spring washer. Axial compensation of play is carried out by means of this spring element 14. Since the rotor shaft 2c is provided with a worm 2d, comparatively high axial displacement forces of the rotor shaft 2c occur during operation. In order to prevent long-term high axial loading on the spring element 14, the electric motor is designed such that in the primary direction of actuation, the rotor shaft 2c axially bears against the opposing bearing, which is to say against the bearing located in the motor housing. If the rotor shaft 2c is operated in the opposite direction at reduced load, then the rotor shaft 2c bears against the spring washer 14 through the cup bearing 12. Said step 13c in the region of the cup bearing seat base 13b has the task of preventing overload of the spring washer 14. Said step 13c keeps the spring washer from being fully compressed.

Independently thereof, during operation the rotor shaft 2c is always kept under defined preloading in the cup bearing by means of the spring washer 14. In this way, it is ensured that the full height of the cup bearing always serves as an effective bearing surface.

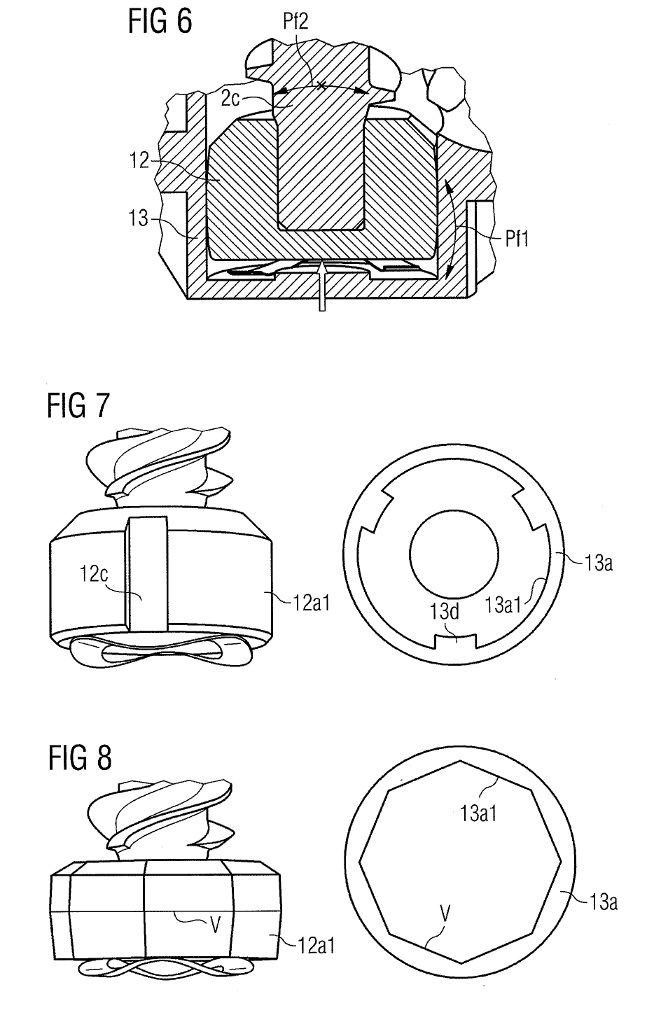

It can additionally be seen in FIG. 5 that the outside 12a1 of the cup bearing side wall 12a is designed to be concave in the axial direction A, which is to say bulging outward, and that the inside 13a1 of the cup bearing seat side wall 13a is straight in design. The advantage of this design is illustrated by the arrow Pf1 in FIG. 6. This arrow Pf1 expresses the fact that, because of the concave configuration of the outside of the cup bearing side wall and the straight design of the inside of the cup bearing seat side wall, the cup bearing can be tilted at least slightly within the cup bearing seat. As a result, angular error in the rotor shaft 2c, which may for example be manufacturing related or caused by installation, can be compensated in advantageous manner.

The crossed-out arrow Pf2 in FIG. 6 is intended to symbolize the fact that the cup bearing 12 should not be able to rotate with rotation of the rotor shaft 2c of the cup bearing 12 during operation of the belt-tensioning drive. To ensure this, in a belt-tensioning drive according to the invention the cup bearing 12 is mounted in a rotationally fixed manner in the cup bearing seat 13 of the gear housing 5.

FIG. 7 shows a view of a cup bearing with a first exemplary embodiment for an anti-rotation device. The cup bearing shown in FIG. 7 has one or more grooves 12c that are let into the outside 12a1 of the cup bearing side wall 12a and that extend in the axial direction. One projection 13d, which is provided on the inside 13a1 of the side wall of the cup bearing seat 13a, engages in each of these grooves 12c. If more such projections are provided, then they can serve to center the spring element 14.

FIG. 8 shows a view of a cup bearing with a second exemplary embodiment for an anti-rotation device. In the case of the cup bearing shown in FIG. 8, the outside 12a1 of the cup bearing side wall 12a has the shape of a polygon V. In like manner, the inside 13a1 of the side wall of the cup bearing seat 13a also has the shape of a polygon V in this exemplary embodiment. This has the result that the polygonal cup bearing surrounded in an interlocking manner by the cup bearing seat 13a cannot rotate in the circumferential direction relative to the cup bearing side wall.

The invention described above accordingly describes a new belt-tensioning concept with a compact construction in which an end region of the rotor shaft of the electric motor serving as the drive motor is mounted in a cup bearing, which cup bearing is placed in a cup bearing seat of the gear housing of the drive. Preferably the cup bearing is at least somewhat tiltable inside the cup bearing seat in order to be able to compensate angular error in the rotor shaft, and is mounted in a rotationally fixed manner in order to prevent the cup bearing from turning along with the rotating rotor shaft during operation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A belt-tensioning drive comprising:
an electric motor containing a rotor shaft;
a gear shaft; and
an output gear,
wherein the electric motor is configured to drive the gear shaft via a first gear train, and the gear shaft is configured to drive the output gear via a second gear train,
wherein the gear shaft is mounted in a gear housing via two bearings,
wherein an end region of the rotor shaft is mounted in a cup bearing and the cup bearing is placed in a cup bearing seat of the gear housing,
wherein the cup bearing has a circumferential cup bearing side wall and a cup bearing base,
wherein the cup bearing seat has a circumferential cup bearing seat side wall and a cup bearing seat base, and
wherein a spring element is positioned between the base of the cup bearing seat and the base of the cup bearing.

2. The belt-tensioning drive according to claim 1, wherein an outer side of the side wall of the cup bearing is concave in an axial direction and an inner side of the side wall of the cup bearing seat is straight in design.

3. The belt-tensioning drive according to claim 1, wherein the cup bearing is mounted in the gear housing in a rotationally fixed manner.

4. The belt-tensioning drive according to claim 3, wherein the outer side of the cup bearing side wall has one or more grooves extending in the axial direction, and wherein the inner side of the side wall of the cup bearing seat is provided with one or more projections engaging the grooves.

5. The belt-tensioning drive according to claim 3, wherein the outer side of the cup bearing side wall and the inner side of the side wall of the cup bearing seat each have the form of a polygon in a circumferential direction.
